(19) United States
(12) Patent Application Publication
(10) Pub. No.: US 2011/0137983 A1
(43) Pub. Date: Jun. 9, 2011

(54) Realization to the Great Volume of Data Based Dynamic Policy

(75) Inventors: ZHIGANG XU, Nanjing (CN); SONG LIU, Nanjing (CN); ZUNPING ZHANG, Nanjing (CN); ZHEN YANG, Nanjing (CN); HUAIZHUANG XU, Nanjing (CN); XIWEI HUANG, Nanjing (CN); ZHIQIANG LU, Nanjing (CN); JIANGUO REN, Nanjing (CN)

(73) Assignee: LINKAGE TECHNOLOGY GROUP CO., LTD., Nanjing (CN)

(21) Appl. No.: 12/962,576

(22) Filed: Dec. 7, 2010

(30) Foreign Application Priority Data
Dec. 8, 2009 (CN) 200910232351.4

(51) Int. Cl. G06F 15/16

(52) U.S. Cl. 709/203

(57) ABSTRACT

The innovation provided an approach to the great volume of data based dynamic policy model, which consists of the steps as the following: 1) User registration in the Differentiation Access & Application Control System (DACS); 2) After user log in Radius system, the user profile is delivered to DACS system where user profile can be recorded; 3) After logging in DACS system, user has option to subscribe the policy for the bandwidth, and the DACS system record the subscribed policy information; 4) User requests to use the subscribed policy via the interface provided by DACS system; 5) After receiving policy requests from user, the DACS system creates a thread which dispatches the policy ordered by subscriber. After finishing above, the result will be returned to subscriber. The innovation supports dynamic policy dispatch in real-time manner for the large number of subscribers, specified bandwidth and QoS according to the service, thus the change from bandwidth control to the dynamic policy model for the service control is realized.

### CROSS REFERENCE TO RELATED PATENT APPLICATION

The present application claims the priority of Chinese patent application No. 200910232351.4 filed on Dec. 8, 2009, which application is incorporated herein by reference.

### FIELD OF THE INVENTION

The innovation is about the realization to the great volume of data based dynamic policy.

### BACKGROUND OF THE INVENTION

With the developing of the network technology, the user requirements for the network quality are becoming higher and higher. When user access to the network, its common thing that user may require a higher bandwidth in some specific period, or for some real-time application. In this case, the dynamic bandwidth adjustment is required, rather than adjust the basic bandwidth of user.

Differentiation Access & Application Control System (DACS) is a control system based on the quality differentiation of broadband network. Depending on the collaboration control of three key network nodes, user access point (Gateway), service access point (BRAS/SR) and content outlet point (IDC outlet), The DACS system is able to control the bandwidth and priority (end-to-end service guarantee can be realized by deployment all over the network), these network nodes control ability can be provided by single as well as multiple under the consideration of customer/service demand. By doing above, the subdivision operation on the broadband network is realized, providing a commercial model which combines the application with the bandwidth guarantee. The DACS system provides the application layer with the transmission control ability, enable application layer have the ability to request the network resource reservation without the knowledge of the underground transmission network. The DACS system evaluates the resource requirements from application layer and makes resource reservation depending on the operator policy, enabling the operator execute the admission control as well as set the independent media flow bearer policy.

### SUMMARY OF THE INVENTION

The innovation aims to provide the realization to the dynamic policy model, which supports real time policy dispatch for bulk user, subdivision of bandwidth and QoS depending on service type. This innovation transits the bandwidth control into the service control.

The innovation puts forward the realization to the great volume of data based dynamic policy model; this model is comprised of admission and control subsystem, network control subsystem, network access subsystem. Please refer to the following for details:

1) User registration in the DACS system; 2) User logs in the remote dial-up system which sends the user information to the DACS system, after that, the user information should be recorded in the DACS system; 3) User logs in the DACS system and orders the policy for bandwidth adjustment, and the subscription details should be recorded by DACS system; 4) User activates the ordered policy via the interface provided by DACS; 5) A thread should be created to dispatch the requested policy when the DACS system receive the request from user;

In the innovation, the dispatch of the ordered policy consists of the following steps:

a) Service provider requests the service policy to the DACS system. Service provider information, user IP, requested policy class is included in the service policy information;

b) According to the user IP, The DACS system inquires the user information, user subscription information and the policy information of the user device, after that, the policy request should be sent to admission control and calculating subsystem;

C) When receive the policy request, the admission control and calculating subsystem should calculate if the resource of each control point can meet the request. If yes, send the resource request to the network policy control subsystem;

D) According to the device type of each control point, the network policy control subsystem generates the relevant network policy and delivers to the network access subsystem;

E) Network access subsystem is responsible for the interaction between DACS system and each of the access devices, and dispatches the network policy to the corresponding devices;

F) After dispatching the policy, network access subsystem return the result to the network policy control subsystem;

g) Policy control subsystem returns the result of policy dispatch to the admission control and calculating subsystem;

h) The admission control and calculating subsystem returns the result of policy dispatch to the service policy control subsystem.

Benefits of the innovation are that user as well as service system can request the DACS system for policy activation or deactivation after subscribing the service, getting approach to adjust the network service quality on demand.

### BRIEF DESCRIPTION OF THE DRAWINGS

FIG. 1 is the work flow of the great volume data based dynamic policy model.

FIG. 2 illustrates the user policy dispatch encompassed in FIG. 1.

### DETAIL DESCRIPTION OF THE INVENTION

To make the targets, features and advantages of the innovation more comprehensible, the optimization case with the diagram is introduced in the following:

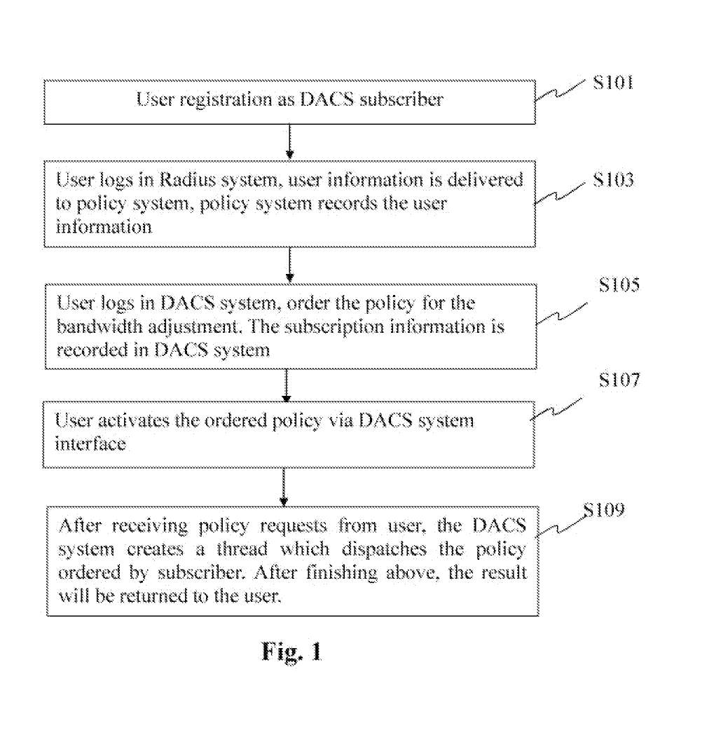

FIG. 1 is the work flow of the great volume data based dynamic policy model.

FIG. 1 description:

S101: User registration as DACS subscriber

S103: User logs in Radius system, user information is delivered to policy system, policy system records the user information

S105: User logs in DACS system, order the policy for the bandwidth adjustment. The subscription information is recorded in DACS system

S107: User activates the ordered policy via DACS system

S109: After receiving policy requests from user, the DACS system creates a thread which dispatches the policy ordered by subscriber. After finishing above, the result will be returned to the user.

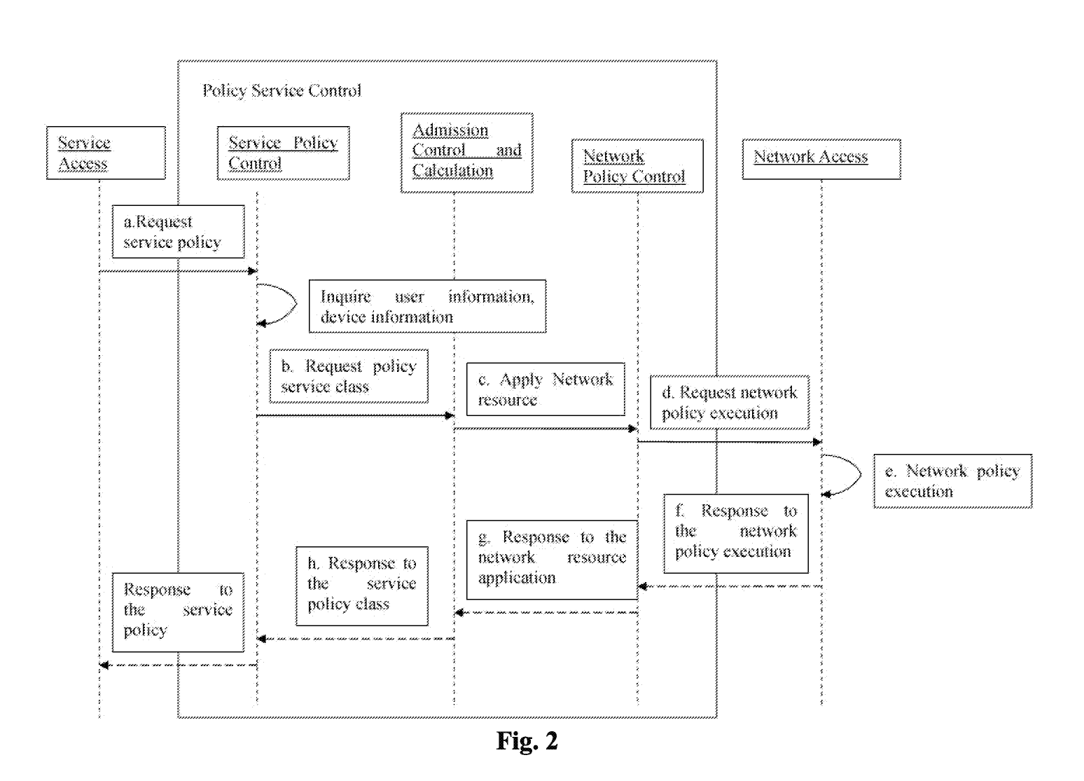

FIG. 2 illustrates the user policy dispatch encompassed in FIG. 1. Please refer to the following for the steps:

a) Service provider requests the service policy to DACS system. Service provider information, user IP, requested policy class is included in the service policy information;

b) According to the user IP, DACS system inquires the user information, user subscription information and the policy information to the user device, after that, the policy request should be sent to admission control and calculating subsystem;

C) When receive the policy request, the admission control and calculating subsystem should calculate if the resource of each control point can meet the request. If yes, send the resource request to the network policy control subsystem;

D) According to the device type of each control point, the network policy control subsystem generates the relevant network policy and delivers to the network access subsystem;

E) Network access subsystem is responsible for the interaction between DACS system and each of the access devices, and dispatch the network policy to the corresponding device;

F) After dispatch the policy, network access subsystem return the result to the network policy control subsystem;

g) Policy control subsystem returns the result of policy dispatch to the admission control and calculating subsystem;

h) The admission control and calculating subsystem return the result of policy dispatch to the service policy control subsystem.

According to the above, the realization to the great volume of data based dynamic policy mainly consists of the following functionalities:

1) User Online/Offline Information:

When user is online and the charging start information is received via Radius system charging notification interface, DACS system updates the user information, modifies the user status as online. After that, DACS system inquires the ordered policy of user, and initiates the policy by policy request flow.

When user is offline and the notification is received via Radius system interface, the DACS system releases the running policy, updates the user information as offline.

2) Policy Application, Policy Release

When user applies policy or release policy, the request is generated. Service policy interface invokes the policy service decision model, and then the policy service decision model executes the policy application/release. The policy application/release flow includes authentication, resource locating, and resource calculating and resource control.

3) Resource Locating

Resource locating is to inquire the user online status, IP of the device to be controlled, device type and bandwidth according to the user (Terminal) IP and the user policy. Resource locating consists of policy information inquiry, control point list inquiry, user locating and device locating. User locating is to figure out the user online status by terminal IP. Device locating is to figure out the information of the device to be controlled by control point, user end IP and service end IP.

3) Resource Calculating

System calculates the usage of the resource, judges if the available resource can meet the user demand, if not, the user request should be rejected.

5) Network Policy Control

Network policy control functionality is to generate multiply network policy items using the information gotten by resource locating. According to the resource operation type (application, release) network policy control functionality executes the network policy or policy cancellation by dispatching the policy items to the corresponding devices via the adaptation interface.

According to the innovation, user is able to control the bandwidth in real time manner based on the need, and the separating service from bearer, unified access of CP/SP, unified adaptation management of network device, subdivision of bandwidth and QoS based on service are realized. Thus, fulfill the conversion from bandwidth control of heavy granularity to service control of slight granularity.

The example given in the innovation is just an optimization case, the case never set any limitation on the realization scope. Therefore, the conversion and the modification which have the same effect as the content of this patent should be considered within the technology scope of this patent.

What is claimed is:

1. A method for realizing great volume of data based dynamic policy model comprising following steps:
1) user registration in the DACS system;
2) user logs in the remote dial-up system which sends the user information to the DACS system, after that, the user information should be recorded in the DACS system;
3) user logs in the DACS system and orders the policy for bandwidth adjustment, and the subscription details should be recorded by DACS system;
4) user activates the ordered policy via the interface provided by DACS;
5) a thread should be created to dispatch the requested policy when the DACS system receives the request from user.

2. The method for realizing great volume of data based dynamic policy model described of claim 1, wherein features the dispatch of the policy, followings describes this in details:
a) service provider request the service policy to the DACS system, service provider information, user IP, requested policy class are included in the service policy information;
b) according to the user IP, The DACS system inquires the user information, user subscription information and the policy information of the user device, after that, the policy request should be sent to admission control and calculating subsystem;
C) when receive the policy request, the admission control and calculating subsystem should calculate if the resource of each control point can meet the request. If yes, send the resource request to the network policy control subsystem;
D) according to the device type of each control point, the network policy control subsystem generates the relevant network policy and delivers to the network access subsystem;
E) network access subsystem is responsible for the interaction between DACS system and each of the access devices, and dispatches the network policy to the corresponding devices;
F) after dispatching the policy, network access subsystem return the result to the network policy control subsystem;
g) policy control subsystem returns the result of policy dispatch to the admission control and calculating subsystem;
h) The admission control and calculating subsystem returns the result of policy dispatch to the service policy control subsystem.
